(19) United States
(12) Patent Application Publication
(10) Pub. No.: US 2012/0309606 A1
(43) Pub. Date: Dec. 6, 2012

(54) Optical Glass and Optical Element

(76) Inventor: Yoshihito Taguchi, Hachioji-shi (JP)

(21) Appl. No.: 13/576,156

(22) PCT Filed: Jan. 27, 2011
(86) PCT No.: PCT/JP2011/051589

§ 371 Date: Jul. 30, 2012

(30) Foreign Application Priority Data
Jan. 28, 2010 (JP) 2010-016538

(51) Int. Cl. C03C 3/21; C03C 3/066; C03C 3/062; C03C 3/19; C03C 3/17

(52) U.S. Cl. 501/46; 501/47; 501/48; 501/73; 501/79

(57) ABSTRACT

An optical glass includes, by mass: 38 to 55% of P₂O₅; 1 to 10% of Al₂O₃; 0 to 5.5% of B₂O₃; 0 to 4% of SiO₂; 3 to 24.5% of BaO; 0 to 15% of SrO; 1 to 10% of CaO; 0.5 to 14.5% of ZnO; 1 to 15% of Na₂O; 1 to 4% of Li₂O; 0 to 4.5% of K₂O; 0 to 0.4% of TiO₂; and 0 to 5% of Ta₂O₅, in which BaO+SrO+CaO+ZnO falls within a range of 25 to 39%, Na₂O+Li₂O+K₂O falls within a range of 5 to 20%, Al₂O₃+SiO₂+CaO+Ta₂O₅ falls within a range of 9 to 18% and P₂O₅+B₂O₃+Al₂O₃+SiO₂+BaO+SrO+CaO+ZnO+Na₂O+Li₂O+K₂O+TiO₂+Ta₂O₅ is equal to 98% or more.

### TECHNICAL FIELD

The present invention relates to optical glasses and optical elements. More particularly, the present invention relates to an optical glass suitable for precision press-molding and an optical element that is formed with such an optical glass.

### BACKGROUND ART

Various optical elements that are formed with optical glasses, such as optical pick-up lenses for optical discs (such as CDs, DVDs, BDs and HD-DVDs) and image-sensing lenses incorporated in mobile telephones are widely used. In recent years, as optical disc recording reproduction devices and camera-incorporating mobile telephones have been rapidly and widely used, the demand for the optical elements formed with the optical glasses described above has been rapidly increased, and thus it is required to increase the productivity of and reduce the cost of such optical elements.

As a method of manufacturing an optical element of a glass lens or the like, a so-called press-molding method is known of pressing glass heated to a yield temperature (At) or more with a heated mold composed of a pair of an upper mold and a lower mold and of thereby molding the optical element directly. In the press-molding method described above, as compared with a conventional forming method using the grinding of glass, the number of manufacturing steps is decreased, and consequently, it is possible to manufacture optical elements for a short period of time and inexpensively. Thus, in recent years, the press-molding method has been widely used as the method of manufacturing optical elements.

The press-molding method described above is broadly divided into two modes, namely, a re-heating mode and a direct-press mode. The re-heating mode is a mode in which a gob preform or a ground preform having the approximate shape of a final product is formed, thereafter the preform is heated again to a softening point or more, it is press-molded with a heated mold composed of a pair of upper and lower molds and thus it has the shape of the final product. On the other hand, the direct-press mode is a mode in which molten glass droplets are directly dropped from a glass melting furnace onto a heated mold and in which press-molding is performed to acquire the shape of a final product. Even in the press-molding method of either of these modes, when the glass is molded, the press-mold needs to be heated close to a glass transition temperature (Tg) or to the glass transition temperature (Tg) or more.

When, in the direct-press mode, the molten glass droplets are dropped, in general, a nozzle made of platinum or the like is used. The weight of the glass dropped is controlled by the temperature of the nozzle. Since, in a glass having a low liquidus temperature (TL), the temperature of the nozzle can be set within a wide temperature range from high to low temperatures, it is possible to form optical elements having various sizes ranging from large to small. By contrast, since, in a glass having a high liquidus temperature (TL), the glass devitrifies unless the temperature of the nozzle is held at the liquidus temperature (TL) or more, it is disadvantageously impossible to perform stable dropping.

When the glass transition temperature (Tg) of a glass is high or when a glass having a high liquidus temperature (TL) is used, since the temperature of the dropped glass itself is also high, it is more likely that the surface of the press-mold is oxidized or the metal composition is changed, with the result that the life of the mold is reduced. This causes the production cost to be increased. Although molding is performed under an inert gas atmosphere such as nitrogen and thus it is possible to reduce the degradation of the mold, since, in order to control the atmosphere, a molding device is complicated and the cost of running the inert gas is need, the production cost is increased. Hence, preferably, in a glass used in the press-molding method, the glass transition temperature (Tg) and the liquidus temperature (TL) are as low as possible. For example, as the optical glass having a low glass transition temperature (Tg), there are optical glasses which are proposed in patent documents 1 to 3 and whose glass transition temperatures (Tg) are 450° C. or less.

When the viscosity of the molten glass is low at the time of molding in the direct-press mode, it is not easy to obtain a shape close to a spherical or aspherical lens in which its curved surface is smooth and uniform. Hence, when the molding is performed, it is necessary to fully examine the viscosity of the molten glass. Moreover, a glass that does not devitrify when dropped needs to be used. When the viscosity of the molten glass is low, the temperature of the molten glass needs to be decreased so that the viscosity of the molten glass is increased; when the temperature is decreased, the temperature drops below the liquidus temperature (TL), and thus devitrification occurs. Hence, a glass whose viscosity is high at the liquidus temperature (TL) is preferably used.

### CITATION LIST

### Patent Literature

Patent document 1: JP-A-H9-301735
Patent document 2: JP-A-2004-217513
Patent document 3: JP-A-2007-145613

### SUMMARY OF INVENTION

### Technical Problem

Although the optical glasses proposed in patent documents 1 to 3 have a low Tg, they disadvantageously have unsatisfactory weather resistance among chemical durabilities. Furthermore, the optical glasses proposed in patent documents 2 and 3 disadvantageously have a low viscosity at the liquidus temperature (TL). A glass having poor weather resistance adversely affects the glass surface, in steps such as a step itself of molding an optical surface by grinding and precision mold press, a cleaning step after the molding of the optical surface and a coating step of molding an optical thin film formed on the surface. This disadvantageously causes yield in the manufacturing process to be reduced. When a glass having a low viscosity is used, it is not easy to obtain satisfactory products at the time of press-molding.

The present invention is made in view of the conventional problems described above; an object of the present invention is to provide an optical glass which has such optical constants that a refractive index (nd) with respect to a d-line is 1.54 to 1.60 and that an Abbe number (νd) is 58 to 67, whose glass transition temperature (Tg) is 420° C. or less, whose liquidus temperature (TL) is 800° C. or less, whose viscosity is 0.8 Pa·s or more at the liquidus temperature (TL) and which has excellent weather resistance and precision press-molding, and is also to provide an optical element that is formed with such an optical glass.

### Solution to Problem

To achieve the above object, an optical glass according to a first aspect of the present invention includes, as glass ingredients, by mass: 38 to 55% of P₂O₅; 1 to 10% of Al₂O₃; 0 to 5.5% of B₂O₃; 0 to 4% of SiO₂; 3 to 24.5% of BaO; 0 to 15% of SrO; 1 to 10% of CaO; 0.5 to 14.5% of ZnO; 1 to 15% of Na₂O; 1 to 4% of Li₂O; 0 to 4.5% of K₂O; 0 to 0.4% of TiO₂; and 0 to 5% of Ta₂O₅, in which BaO+SrO+CaO+ZnO falls within a range of 25 to 39%, Na₂O+Li₂O+K₂O falls within a range of 5 to 20%, Al₂O₃+SiO₂+CaO+Ta₂O₅ falls within a range of 9 to 18% and P₂O₅+B₂O₃+Al₂O₃+SiO₂+BaO+SrO+CaO+ZnO+Na₂O+Li₂O+K₂O+TiO₂+Ta₂O₅ is equal to 98% or more. Unless otherwise particularly specified, “%” means “mass %” in the following description.

In the first aspect of the present invention, the optical glass according to a second aspect of the present invention has such optical constants that a refractive index (nd) is 1.54 to 1.60 and that an Abbe number (νd) is 58 to 67, has a glass transition temperature (Tg) of 420° C. or less, has a liquidus temperature (TL) of 800° C. or less and has a viscosity of 0.8 Pa·s or more at the liquidus temperature (TL).

The optical element according to a third aspect of the present invention is formed with the optical glass according to the first or second aspect of the present invention. Examples of such an optical element include a lens, a prism and a mirror.

The optical element according to a fourth aspect of the present invention is made by performing precision press-molding on the optical glass according to the first or second aspect of the present invention.

### Advantageous Effects of Invention

According to the present invention, by having specific amounts of predetermined glass ingredients contained, it is possible to obtain, without using compounds such as PbO, CdO, As₂O₃ and Sb₂O₃ that are expected to adversely affect human bodies, an optical glass which has such optical constants that a refractive index (nd) is 1.54 to 1.60 and that an Abbe number (νd) is 58 to 67, whose glass transition temperature (Tg) is 420° C. or less, whose liquidus temperature (TL) is 800° C. or less, whose viscosity is 0.8 Pa·s or more at the liquidus temperature (TL) and which has excellent weather resistance and precision press-molding. Since the optical element of the present invention can be made by performing precision press-molding on the optical glass, it is possible to increase the production efficiency and reduce the cost while the properties of the optical glass described above are maintained.

### DESCRIPTION OF EMBODIMENTS

Reasons and the like for limiting, as described above, the composition range of individual ingredients of an optical glass according to the present invention will be described below.

P₂O₅ is an ingredient (glass former) that forms the skeleton of a glass; when its content is 38% or less, the glass becomes unstable and thus tends more to devitrify. On the other hand, when the P₂O₅ content is 55% or more, the devitrification resistance and the stability of the glass are enhanced, but it is impossible to obtain desired optical constants. This also results in significantly poor weather resistance. Hence, the P₂O₅ content is set within a range of 38 to 55%. The P₂O₅ content more preferably falls within a range of 40 to 54%. The P₂O₅ content most preferably falls within a range of 42 to 53%.

Al₂O₃ has the effect of reducing the linear thermal expansion coefficient and of enhancing the weather resistance of the glass. It also has the effect of increasing the viscosity. When the Al₂O₃ content is less than 1%, it is impossible to sufficiently obtain the effects described above. On the other hand, when the Al₂O₃ content exceeds 10%, the glass transition temperature (Tg) is increased, and the glass becomes unstable and tends more to devitrify. Hence, the Al₂O₃ content is set within a range of 1 to 10%. The Al₂O₃ content more preferably falls within a range of 1.5 to 9%. The Al₂O₃ content most preferably falls within a range of 2 to 8%.

B₂O₃ has the effect of stabilizing the glass and of reducing the linear thermal expansion coefficient. When the B₂O₃ content exceeds 5.5%, the glass transition temperature (Tg) is increased, and the viscosity is decreased, with the result that the devitrification resistance is likely to be decreased. Hence, the B₂O₃ content is set within a range of 0 to 5.5%. The B₂O₃ content more preferably falls within a range of 0 to 5%. The B₂O₃ content most preferably falls within a range of 0 to 4.5%.

Although SiO₂ has the effect of reducing the refractive index and of enhancing the weather resistance, when its content exceeds 4%, part of the glass is more likely to be left unmelted. Hence, the SiO₂ content is set equal to or less than 4%. The SiO₂ content is more preferably 3.5% or less. The SiO₂ content is most preferably 3% or less.

BaO has the effect of reducing the glass transition temperature (Tg), of increasing the refractive index and of enhancing the stability of the glass. When the BaO content is less than 3%, it is impossible to sufficiently obtain the effects described above. On the other hand, when the BaO content is more than 24.5%, the linear thermal expansion coefficient is increased. Hence, the BaO content is set within a range of 3 to 24.5%. The BaO content more preferably falls within a range of 5 to 24%. The B₂O content most preferably falls within a range of 7 to 23.5%.

SrO has the effect of enhancing the stability of the glass. When the SrO content exceeds 15%, the glass becomes unstable and thus tends more to devitrify, and the specific gravity is increased. Hence, the SrO content is set within a range of 0 to 15%. The SrO content more preferably falls within a range of 0 to 13%. The SrO content most preferably falls within a range of 0 to 12%.

CaO has the effect of decreasing the linear thermal expansion coefficient and of enhancing the chemical durability and the weather resistance of the glass. When the CaO content is less than 1%, it is not easy to obtain the effects described above; when the CaO content exceeds 10%, the glass transition temperature (Tg) is increased, and the glass becomes unstable and thus tends more to devitrify. Hence, the CaO content is set within a range of 1 to 10%. The CaO content more preferably falls within a range of 3 to 9.5%. The CaO content most preferably falls within a range of 4 to 9.5%.

ZnO has the effect of reducing the glass transition temperature (Tg) without increasing the linear thermal expansion coefficient. When the ZnO content is less than 0.5%, it is impossible to sufficiently obtain the effect of reducing the glass transition temperature (Tg). On the other hand, when the ZnO content exceeds 14.5%, the glass is reduced in stability and tends more to devitrify. Hence, the ZnO content is set within a range of 0.5 to 14.5%. The ZnO content more preferably falls within a range of 1 to 14%. The ZnO content most preferably falls within a range of 2 to 14%.

In order to reduce the glass transition temperature (Tg) and enhance the stability and the devitrification resistance of the glass, the total amount of RO ingredients (R=Ba, Sr, Ca and Zn) described above is set within a range of 25 to 39%. When the total amount of RO ingredients is less than 25%, it is impossible to obtain the effects described above. On the other hand, when the total amount of RO ingredients exceeds 39%, the stability of the glass is degraded, and the glass tends more to devitrify. The total amount of RO ingredients more preferably falls within a range of 27 to 38.5%. The total amount of RO ingredients most preferably falls within a range of 28 to 38.5%.

Li₂O has the effect of greatly reducing the glass transition temperature (Tg). When the Li₂O content is less than 1%, it is impossible to sufficiently obtain the effect described above. On the other hand, when the Li₂O content exceeds 4%, the linear thermal expansion coefficient is increased, and the weather resistance of the glass is significantly reduced. The viscosity is also reduced. Hence, the Li₂O content is set within a range of 1 to 4%. The Li₂O content more preferably falls within a range of 1.5 to 3.5%.

Na₂O has the effect of reducing the glass transition temperature (Tg) though the effect is lower than that of Li₂O. When the Na₂O content is less than 1%, it is not easy to obtain the effect described above, and the stability of the glass is reduced. When the Na₂O content exceeds 15%, the chemical durability is reduced, and the viscosity of the glass is also reduced. Hence, the Na₂O content is set within a range of 1 to 15%. The Na₂O content more preferably falls within a range of 2 to 13%. The Na₂O content most preferably falls within a range of 2.5 to 12%.

As with Na₂O described above, K₂O has the effect of reducing the glass transition temperature (Tg) though the effect is lower than that of Li₂O. When the K₂O content exceeds 4.5%, the devitrification resistance is reduced. Hence, the K₂O content is set within a range of 0 to 4.5%. The K₂O content more preferably falls within a range of 0 to 4%.

In order to enhance the devitrification resistance and the weather resistance, the total amount of R′₂O ingredients (R′=Li, Na and K) described above is set within a range of 5 to 20%. When the total amount of R′₂O ingredients is less than 5%, it is impossible to sufficiently obtain the effect of reducing the glass transition temperature (Tg). On the other hand, when the total amount of R′₂O ingredients exceeds 20%, the viscosity of the glass is reduced, and the weather resistance is degraded. The total amount of R′₂O ingredients more preferably falls within a range of 6 to 18%. The total amount of R′₂O ingredients most preferably falls within a range of 7 to 16%.

Although TiO₂ has the effect of increasing the refractive index and of stabilizing the glass, when the TiO₂ content is more than 0.4%, the Abbe number is decreased, it is impossible to obtain desired optical constants and the glass is likely to be colored. Hence, the TiO₂ content falls within a range of 0 to 0.4%. The TiO₂ content more preferably falls within a range of 0 to 0.3%.

Ta₂O₅ has the effect of adjusting the optical constants and of enhancing the chemical durability. When the Ta₂O₅ content exceeds 5%, the glass becomes unstable and is likely to tend more to devitrify. Hence, the Ta₂O₅ content is set within a range of 0 to 5%. The Ta₂O₅ content more preferably falls within a range of 0 to 4%. The Ta₂O₅ content most preferably falls within a range of 0 to 3%.

In order to maintain the high weather resistance, the total amount of Al₂O₃, SiO₂, CaO and Ta₂O₅ is set within a range of 9 to 18%. When the total amount is less than 9%, it is difficult to maintain the high weather resistance; when the total amount is more than 18%, the devitrification resistance is degraded. Hence, the total amount more preferably falls within a range of 9.5 to 17%. The total amount most preferably falls within a range of 10 to 16%.

In the optical glass of the present invention, among ingredients used in general optical glasses, ingredients (for example, MgO, La₂O₃, Y₂O₃, Gd₂O₃, ZrO₂, GeO₂, MnO, Nb₂O₅, Bi₂O₃ and WO₃) other than those described above are not practically contained. However, such amounts of those ingredients that the properties of the optical glass of the present invention are not affected are allowed to be contained. In this case, the total content of P₂O₅, B₂O₃, Al₂O₃, SiO₂, BaO, SrO, ZnO, CaO, Li₂O, Na₂O, K₂O, TiO₂ and Ta₂O₅ is preferably 98.0% or more. The total content is more preferably 99.0% or more; it is further preferably 99.9% or more.

In terms of coloring, Nb₂O₅, Bi₂O₃ and WO₃ are not practically contained. Moreover, in terms of devitrification resistance, MgO, La₂O₃, Y₂O₃, Gd₂O₃, ZrO₂ and GeO₂ are not practically contained.

Preferably, in consideration of working conditions at the time of manufacturing, in order for the safety of an operator to be acquired, no ingredients of PbO, CdO, As₂O₃, TeO₂ and fluorides are contained.

The composition range of the individual ingredients is limited as described above, and thus it is possible to provide, without using compounds such as PbO, CdO, As₂O₃ and Sb₂O₃ that are expected to adversely affect human bodies, an optical glass which has such optical constants that a refractive index (nd) is 1.54 to 1.60 and that an Abbe number (νd) is 58 to 67, whose glass transition temperature (Tg) is 420° C. or less, whose liquidus temperature (TL) is 800° C. or less, whose viscosity is 0.8 Pa·s or more at the liquidus temperature (TL) and which has excellent weather resistance and precision press-molding. Devitrification is unlikely to occur due to the low liquidus temperature (TL), and thus it is possible to perform stable dropping. Since the low glass transition temperature (Tg) allows the temperature of the press-mold to be reduced, the life of the mold is increased, and thus it is possible to reduce the production cost. The high viscosity at the liquidus temperature (TL) allows the proportion of satisfactory products to be increased at the time of press-molding, and thus it is possible to enhance the productivity.

The optical glass of the present invention is used as the material of optical elements (such as a lens, a prism and a mirror) incorporated in optical devices such as a digital camera and a camera-incorporating mobile telephone, and thus it is possible to enhance the productivity of and reduce the cost of the optical elements by enhancement of the weather resistance and the precision press-molding, with the result that it is possible to facilitate cost reduction on the optical devices and the like.

The optical element of the present invention is made by performing precision press-molding on the optical glass. As the precision press-molding method, as described above, there are two methods below: the direct-press method in which molten glass is dropped from a nozzle onto a mold heated to a predetermined temperature and press-molding is performed; and the re-heating method in which a preform material is placed on a mold, and it is heated to a softening point or more and is press-molded. With the methods described above, the cutting/grinding process is not needed, the productivity is enhanced and it is possible to obtain an optical element of a shape such as a free-form surface or an aspherical surface that is difficult to process. Thus, it is possible to reduce the cost.

### EXAMPLES

The configuration and the like of the optical glass on which the present invention has been practiced will be further specifically described using examples 1 to 24, comparative example 1 to 3 and the like. In the comparative example 1, example 12 disclosed in patent document 1 was tested again; in the comparative example 2, example 11 disclosed in patent document 2 was tested again; in the comparative example 3, example 9 disclosed in patent document 3 was tested again.

General glass materials such as an oxide material, a carbonate material and a nitrate material were used, and the glass materials were prepared so as to satisfy target compositions (mass %) shown in Tables 1 to 4, were fully mixed in their powder form and were used as prepared materials. They were put into a melting furnace that was heated to 800 to 1300° C., and were melted and clarified and then evenly agitated and were molded into a previously heated metal mold, and were gradually cooled, with the result that individual samples were manufactured. For each of the samples, the refractive index (nd) with respect to a d-line, the Abbe number (νd), the glass transition temperature (Tg), the liquidus temperature (TL) and the viscosity were measured. A weather resistance test was performed with a weather resistance tester. The measurement results were shown in Tables 1 to 4.

(1) The Refractive Index (nd) and the Abbe Number (νd)

As described above, the glass melted and poured into the mold was cooled at a rate of −2.3° C. per hour. The samples were measured with “KPR-2000” made by Kalnew Optical Industrial Co., Ltd.

(2) The Glass Transition Temperature (Tg)

The measurements were performed at a temperature rise of 10° C. per minute, using a thermomechanical analyzer “TMA/SS6000” made by Seiko Instruments Inc.

(3) The Liquidus Temperature (TL)

In the measurement of the liquidus temperature (TL), the molten glass poured into the mold within a devitrification test furnace having a temperature gradient of 800 to 1400° C. was maintained for 12 hours, and thereafter the glass was cooled to a room temperature and the inside of the glass was observed with an optical microscope (BX50) having a magnification of 40 made by Olympus Corporation. Then, the temperature at which devitrification (crystal) was not observed within the glass was assumed to be the liquidus temperature (TL).

(4) The Viscosity

The viscosity (Pa·s) at the TL was measured with a high-temperature viscosity measurement device “TVE-20H” made by Tokimec, Inc.

(5) The Weather Resistance Test

An environmental tester “SH-641” made by ESPEC Corporation was used, and the individual samples were maintained for 168 hours in a constant temperature and humidity chamber whose temperature is 60° C. and whose humidity is 95%. Thereafter, the surfaces of the individual samples were observed with the optical microscope (BX50) made by Olympus Corporation. The magnification of the optical microscope was set at 40. In Table 1 to 4, as a result of the observation with the optical microscope, “O” indicates that changes such as clouding, precipitation and melting were not observed on the surface (that the weather resistance was satisfactory), and “x” indicates that changes such as clouding, precipitation and melting were observed on the surface (that the weather resistance was unsatisfactory).

TABLE 1

| | | EXAMPLE 1 | EXAMPLE 2 | EXAMPLE 3 | EXAMPLE 4 |
|---|---|---|---|---|---|
| COMPOSITION | P2O5 | 49.00 | 49.00 | 48.80 | 49.00 |
| (MASS | Al2O3 | 4.00 | 2.50 | 4.20 | 4.00 |
| %) | B2O3 | 0.50 | 0.30 | 0.30 | 0.50 |
| | SiO2 | | | | |
| | BaO | 20.90 | 22.40 | 23.00 | 18.90 |
| | SrO | | | | |
| | ZnO | 6.50 | 5.50 | 6.00 | 6.50 |
| | CaO | 7.50 | 7.20 | 6.30 | 9.50 |
| | Na2O | 5.60 | 4.80 | 5.80 | 5.60 |
| | Li2O | 2.70 | 2.80 | 2.60 | 2.70 |
| | K2O | 3.30 | 3.70 | 3.00 | 3.30 |
| | TiO2 | | | | |
| | Ta2O5 | | 1.80 | | |
| | TOTAL | 100.00 | 100.00 | 100.00 | 100.00 |
| | TOTAL OF RO | 34.900 | 35.100 | 35.300 | 34.900 |
| | TOTAL OF R′2O | 11.60 | 11.30 | 11.40 | 11.60 |
| | TOTAL OF A | 11.50 | 11.50 | 10.50 | 13.50 |
| nd | | 1.57340 | 1.58239 | 1.57620 | 1.57379 |
| νd | | 64.28 | 63.21 | 64.52 | 64.10 |
| Tg (° C.) | | 387 | 413 | 392 | 414 |
| TL (° C.) | | 740 | 800 | 780 | 780 |
| VISCOSITY AT TL (Pa · s) | | 1.5 | 1.0 | 1.2 | 1.2 |
| WEATHER RESISTANCE TEST | | ◯ | ◯ | ◯ | ◯ |
| | | EXAMPLE 5 | EXAMPLE 6 | EXAMPLE 7 | EXAMPLE 8 |
| COMPOSITION | P2O5 | 49.00 | 49.00 | 49.00 | 49.00 |
| (MASS | Al2O3 | 4.50 | 4.00 | 5.50 | 5.00 |
| %) | B2O3 | 3.00 | 2.50 | 0.50 | 0.50 |
| | SiO2 | | | | |
| | BaO | 18.90 | 19.90 | 16.90 | 21.90 |
| | SrO | | | | |
| | ZnO | 6.50 | 6.50 | 6.50 | 5.50 |
| | CaO | 7.50 | 7.50 | 9.00 | 6.50 |
| | Na2O | 4.60 | 4.60 | 6.60 | 5.60 |
| | Li2O | 2.70 | 2.70 | 3.00 | 2.70 |
| | K2O | 3.30 | 3.30 | 3.00 | 3.30 |
| | TiO2 | | | | |
| | Ta2O5 | | | | |
| | TOTAL | 100.00 | 100.00 | 100.00 | 100.00 |
| | TOTAL OF RO | 32.900 | 33.900 | 32.400 | 33.900 |
| | TOTAL OF R′2O | 10.60 | 10.60 | 12.60 | 11.60 |
| | TOTAL OF A | 12.00 | 11.50 | 14.50 | 11.50 |

| | | | | |
|---|---|---|---|---|
| nd | 1.57099 | 1.57757 | 1.57242 | 1.57460 |
| νd | 65.52 | 64.90 | 64.30 | 64.75 |
| Tg (° C.) | 389 | 396 | 415 | 388 |
| TL (° C.) | 760 | 780 | 800 | 760 |
| VISCOSITY AT TL (Pa · s) | 1.4 | 1.0 | 1.7 | 1.9 |
| WEATHER RESISTANCE TEST | ◯ | ◯ | ◯ | ◯ |

TOTAL OF A: Al2O3 + SiO2 + CaO + Ta2O5

TABLE 2

| | | EXAMPLE 9 | EXAMPLE 10 | EXAMPLE 11 | EXAMPLE 12 |
|---|---|---|---|---|---|
| COMPOSITION | P2O5 | 49.50 | 44.00 | 49.00 | 50.00 |
| (MASS | Al2O3 | 2.50 | 3.50 | 4.00 | 4.10 |
| %) | B2O3 | 0.30 | 3.00 | 0.50 | |
| | SiO2 | 1.00 | | | |
| | BaO | 23.20 | 22.00 | 22.90 | 14.50 |
| | SrO | | 4.50 | | 9.00 |
| | ZnO | 5.00 | 3.00 | 5.50 | 5.60 |
| | CaO | 7.20 | 9.00 | 6.50 | 6.40 |
| | Na2O | 5.10 | 6.70 | 5.60 | 5.00 |
| | Li2O | 2.70 | 2.50 | 2.70 | 3.00 |
| | K2O | 3.50 | 1.80 | 3.30 | 2.20 |
| | TiO2 | | | | 0.20 |
| | Ta2O5 | | | | |
| | TOTAL | 100.00 | 100.00 | 100.00 | 100.00 |
| | TOTAL OF RO | 35.400 | 38.500 | 34.900 | 35.500 |
| | TOTAL OF R′2O | 11.30 | 11.00 | 11.60 | 10.20 |
| | TOTAL OF A | 10.70 | 12.50 | 10.50 | 10.50 |
| nd | | 1.57726 | 1.58221 | 1.57437 | 1.58037 |
| νd | | 64.95 | 60.86 | 64.68 | 62.79 |
| Tg (° C.) | | 410 | 410 | 386 | 382 |
| TL (° C.) | | 800 | 800 | 760 | 770 |
| VISCOSITY AT TL (Pa · s) | | 1.1 | 1.3 | 1.2 | 0.9 |
| WEATHER RESISTANCE TEST | | ◯ | ◯ | ◯ | ◯ |
| | | EXAMPLE 13 | EXAMPLE 14 | EXAMPLE 15 | EXAMPLE 16 |
| COMPOSITION | P2O5 | 51.00 | 49.00 | 49.00 | 49.00 |
| (MASS | Al2O3 | 4.00 | 4.50 | 4.00 | 4.00 |
| %) | B2O3 | 0.50 | 0.50 | | 0.50 |
| | SiO2 | | | | |
| | BaO | 18.90 | 21.90 | 22.90 | 21.90 |
| | SrO | | | | |
| | ZnO | 6.50 | 5.50 | 6.00 | 5.50 |
| | CaO | 7.50 | 7.00 | 6.50 | 7.50 |
| | Na2O | 5.60 | 5.60 | 5.60 | 5.60 |
| | Li2O | 2.70 | 2.70 | 2.70 | 2.70 |
| | K2O | 3.30 | 3.30 | 3.30 | 3.30 |
| | TiO2 | | | | |
| | Ta2O5 | | | | |
| | TOTAL | 100.00 | 100.00 | 100.00 | 100.00 |
| | TOTAL OF RO | 32.900 | 34.400 | 35.400 | 34.900 |
| | TOTAL OF R′2O | 11.60 | 11.60 | 11.60 | 11.60 |
| | TOTAL OF A | 11.50 | 11.50 | 10.50 | 11.50 |

| | | | | |
|---|---|---|---|---|
| nd | 1.56192 | 1.57461 | 1.57587 | 1.57483 |
| νd | 65.80 | 64.71 | 64.92 | 64.66 |
| Tg (° C.) | 376 | 408 | 376 | 393 |
| TL (° C.) | 730 | 780 | 750 | 780 |
| VISCOSITY AT TL (Pa · s) | 1.7 | 1.0 | 1.4 | 1.0 |
| WEATHER RESISTANCE TEST | ◯ | ◯ | ◯ | ◯ |

TOTAL OF A: Al2O3 + SiO2 + CaO + Ta2O5

TABLE 3

| | | EXAMPLE 17 | EXAMPLE 18 | EXAMPLE 19 | EXAMPLE 20 |
|---|---|---|---|---|---|
| COMPOSITION | P2O5 | 49.00 | 49.00 | 48.00 | 48.50 |
| (MASS | Al2O3 | 4.00 | 4.00 | 4.30 | 3.70 |
| %) | B2O3 | 2.50 | 2.50 | | 0.70 |
| | SiO2 | | | | |
| | BaO | 20.90 | 18.90 | 22.70 | 22.50 |
| | SrO | | | 2.50 | |
| | ZnO | 6.50 | 6.50 | 5.20 | 5.80 |
| | CaO | 7.50 | 7.50 | 6.00 | 6.80 |
| | Na2O | 3.60 | 5.60 | 5.30 | 6.00 |
| | K2O | 2.70 | 2.70 | 2.90 | 2.80 |
| | K2O | 3.30 | 3.30 | 3.10 | 3.20 |
| | TiO2 | | | | |
| | Ta2O5 | | | | |
| | TOTAL | 100.00 | 100.00 | 100.00 | 100.00 |
| | TOTAL OF RO | 34.900 | 32.900 | 36.400 | 35.100 |
| | TOTAL OF R′2O | 9.60 | 11.60 | 11.30 | 12.00 |
| | TOTAL OF A | 11.50 | 11.50 | 10.30 | 10.50 |
| nd | | 1.57789 | 1.57312 | 1.56970 | 1.57211 |
| νd | | 65.00 | 65.00 | 64.67 | 64.73 |
| Tg (° C.) | | 402 | 392 | 391 | 389 |
| TL (° C.) | | 790 | 770 | 760 | 770 |
| VISCOSITY AT TL (Pa · s) | | 1.8 | 1.1 | 1.3 | 1.0 |
| WEATHER RESISTANCE TEST | | ◯ | ◯ | ◯ | ◯ |
| | | EXAMPLE 21 | EXAMPLE 22 | EXAMPLE 23 | EXAMPLE 24 |
| COMPOSITION | P2O5 | 49.00 | 49.00 | 49.20 | 49.00 |
| (MASS | Al2O3 | 4.50 | 4.00 | 3.90 | 3.50 |
| %) | B2O3 | 3.00 | 0.50 | 1.00 | 0.50 |
| | SiO2 | | | | |
| | BaO | 17.90 | 20.90 | 10.00 | 21.40 |
| | SrO | | 2.00 | 6.70 | |
| | ZnO | 6.50 | 6.50 | 11.00 | 6.10 |
| | CaO | 7.50 | 7.50 | 6.70 | 7.50 |
| | Na2O | 5.60 | 3.60 | 5.50 | 9.00 |
| | Li2O | 2.70 | 2.70 | 2.70 | 2.00 |
| | K2O | 3.30 | 3.30 | 3.30 | |
| | TiO2 | | | | |
| | Ta2O5 | | | | 1.00 |
| | TOTAL | 100.00 | 100.00 | 100.00 | 100.00 |
| | TOTAL OF RO | 31.900 | 36.900 | 34.400 | 35.000 |
| | TOTAL OF R′2O | 11.60 | 9.60 | 11.50 | 11.00 |
| | TOTAL OF A | 12.00 | 11.50 | 10.60 | 12.00 |

| | | | | |
|---|---|---|---|---|
| nd | 1.56895 | 1.57955 | 1.56212 | 1.57927 |
| νd | 65.39 | 64.70 | 63.98 | 63.90 |
| Tg (° C.) | 382 | 391 | 398 | 404 |
| TL (° C.) | 760 | 770 | 780 | 790 |
| VISCOSITY AT TL (Pa · s) | 1.2 | 1.3 | 1.2 | 1.0 |
| WEATHER RESISTANCE TEST | 603 | ◯ | ◯ | ◯ |

TOTAL OF A: Al2O3 + SiO2 + CaO + Ta2O5

TABLE 4

| | | COMPARATIVE | COMPARATIVE | COMPARATIVE |
|---|---|---|---|---|
| | | EXAMPLE 1 | EXAMPLE 2 | EXAMPLE 3 |
| COMPOSITION | P2O5 | 53.00 | 44.60 | 47.91 |
| (MASS | Al2O3 | 4.95 | | |
| %) | B2O3 | | 0.30 | |
| | BaO | | 30.70 | 28.82 |
| | ZnO | 12.03 | 8.50 | 10.06 |
| | CaO | 6.01 | 1.50 | 1.25 |
| | Na2O | 5.03 | 5.60 | 3.58 |
| | Li2O | 8.02 | 2.70 | 1.72 |
| | K2O | 4.99 | 3.30 | 3.65 |
| | TiO2 | 2.97 | | |
| | Nb2O5 | 3.00 | | |
| | Bi2O3 | | 2.80 | |
| | Sb2O3 | | | 3.00 |
| | TOTAL | 100.00 | 100.00 | 100.00 |

| | | | |
|---|---|---|---|
| nd | 1.58615 | 1.58367 | 1.58189 |
| νd | 49.97 | 59.56 | 59.82 |
| Tg (° C.) | 342 | 320 | 328 |
| TL (° C.) | 660 | 700 | 740 |
| VISCOSITY AT TL (Pa · s) | 2.0 | 0.5 | 0.5 |
| WEATHER RESISTANCE TEST | X | X | X |

As obvious from the measurement results mentioned above, in Examples 1 to 24 (Tables 1 to 3), the weather resistance was satisfactory whereas, in Comparative Examples 1 to 3 (Table 4), the weather resistance was unsatisfactory.

1.-4. (canceled)

5. An optical glass comprising, as glass ingredients, by mass:
38 to 55% of P2O5;
1 to 10% of Al2O3;
0 to 0.7% of B2O3;
0 to 4% of SiO2;
3 to 24.5% of BaO;
0 to 15% of SrO;
1 to 10% of CaO;
0.5 to 14.5% of ZnO;
1 to 15% of Na2O;
1 to 4% of Li2O;
0 to 4.5% of K2O;
0 to 0.4% of TiO2; and
0 to 5% of Ta2O5,
wherein BaO+SrO+CaO+ZnO falls within a range of 25 to 39%,
Na2O+Li2O+K2O falls within a range of 5 to 20%,
Al2O3+SiO2+CaO+Ta2O5 falls within a range of 9 to 18% and
P2O5+B2O3+Al2O3+SiO2+BaO+SrO+CaO+ZnO+Na2O+Li2O+K2O+TiO2+Ta2O5 is equal to 98% or more.

6. The optical glass of claim 5,
wherein 40 to 54% of P2O5 by mass is included.

7. The optical glass of claim 5,
wherein 5 to 24% of BaO by mass is included.

8. The optical glass of claim 5,
wherein 1 to 14% of ZnO by mass is included.

9. The optical glass of claim 5,
wherein 3 to 9.5% of CaO by mass is included.

10. The optical glass of claim 5,
wherein 2 to 13% of Na2O by mass is included.

11. The optical glass of claim 5,
wherein 1.5 to 3.5% of Li2O by mass is included.

12. The optical glass of claim 5,
wherein 1.5 to 9% of Al2O3 by mass is included.

13. The optical glass of claim 5,
wherein 0 to 4% of K2O by mass is included.

14. The optical glass of claim 5,
wherein 0 to 13% of SrO by mass is included.

15. The optical glass of claim 5,
wherein 0 to 3.5% of SiO2 by mass is included.

16. The optical glass of claim 5,
wherein 0 to 0.3% of TiO2 by mass is included.

17. The optical glass of claim 5,
wherein 0 to 4% of Ta205 by mass is included.

18. The optical glass of claim 5 which has such optical constants that a refractive index (nd) is 1.54 to 1.60 and that an Abbe number (νd) is 58 to 67,
which has a glass transition temperature (Tg) of 420° C. or less,
which has a liquidus temperature (TL) of 800° C. or less and
which has a viscosity of 0.8 Pa·s or more at the liquidus temperature (TL).

19. The optical glass of claim 2 which has such optical constants that a refractive index (nd) is 1.54 to 1.60 and that an Abbe number (νd) is 58 to 67,
which has a glass transition temperature (Tg) of 420° C. or less,
which has a liquidus temperature (TL) of 800° C. or less and
which has a viscosity of 0.8 Pa·s or more at the liquidus temperature (TL).

20. An optical element that is formed with the optical glass of claim 5.

21. The optical element of claim 20,
wherein the optical element is formed by press-molding.
